(19) United States
(12) Patent Application Publication
(10) Pub. No.: US 2023/0102760 A1
(43) Pub. Date: Mar. 30, 2023

(54) APPARATUS FOR DETECTING A TRAFFIC FLOW OBSTRUCTION TARGET AND A METHOD THEREOF

(71) Applicants: HYUNDAI MOTOR COMPANY, Seoul (KR); KIA CORPORATION, Seoul (KR)

(72) Inventor: Tae Dong Oh, Seoul (KR)

(73) Assignees: HYUNDAI MOTOR COMPANY, Seoul (KR); KIA CORPORATION, Seoul (KR)

(21) Appl. No.: 17/740,050

(22) Filed: May 9, 2022

(30) Foreign Application Priority Data
Sep. 28, 2021 (KR) 10-2021-0128191

(51) Int. Cl. B60W 60/00; B60W 40/04

(52) U.S. Cl. CPC B60W 60/0027; B60W 40/04; B60W 2554/4041; B60W 2552/53; B60W 2556/10; B60W 2556/45; B60W 2420/42

(57) ABSTRACT

An apparatus and a method in an autonomous vehicle detect a traffic flow obstruction target. The apparatus detects information about at least one of a speed of another vehicle, a driving path of the other vehicle, or a position of the other vehicle. The apparatus calculates a degree to which the other vehicle interferes with traffic flow, based on the detected information and based on high definition map information stored in a memory. The apparatus selects a traffic flow obstruction target, based on the degree to which the other vehicle interferes with the traffic flow. The apparatus detects a target causing bypass driving, which is present on a driving path, to enhance the continued operation of autonomous driving.

### CROSS-REFERENCE TO RELATED APPLICATION

This application claims the benefit of priority to Korean Patent Application No. 10-2021-0128191, filed in the Korean Intellectual Property Office on Sep. 28, 2021, the entire contents of which are incorporated herein by reference.

### TECHNICAL FIELD

The present disclosure relates to an apparatus for detecting a traffic flow obstruction target and a method thereof, and more particularly, relates to the apparatus for detecting the traffic flow obstruction target, which is provided in an autonomous vehicle, and to a method thereof.

### BACKGROUND

There are currently targets (e.g., vehicles, obstacles), causing bypass driving of an autonomous vehicle (e.g., causing an autonomous vehicle to bypass or drive around the target) due to a vehicle parked and stopped on a shoulder, a vehicle attempting to narrow and enter an interval with a forward vehicle at an intersection (e.g., a vehicle changing lanes and decreasing a distance to a forward vehicle), a vehicle crossing the line by stopping a lane change while making the lane change, or the like, on the road. Because an existing autonomous vehicle system does not have a method capable of determining targets causing bypass driving, which are present on a driving path, autonomous driving control is frequently released. Particularly, the autonomous vehicle system may recognize an object or target, which is present around an autonomous vehicle by means of a light detection and ranging (LiDAR), a camera, or a radar provided in the autonomous vehicle. Furthermore, the autonomous vehicle system may utilize or rely on high definition map information to detect objects or targets, such as other vehicles, which are present on a high definition map.

### SUMMARY

Thus, there is a need for developing a technology in which an autonomous vehicle detects targets causing bypass driving, using recognition information, high definition map information, and the like, selects a new bypass driving path of the autonomous vehicle with regard to the targets, and performs autonomous driving along the new bypass driving path.

The present disclosure has been made to solve the above-mentioned problems occurring in the prior art while advantages achieved by the prior art are maintained intact.

An aspect of the present disclosure provides an apparatus and a method of an autonomous vehicle for detecting a traffic flow obstruction target.

Another aspect of the present disclosure provides an apparatus and a method for detecting a traffic flow obstruction target to detect a target causing bypass driving, which is present on a driving path, to enhance continued or uninterrupted operation of autonomous driving.

Another aspect of the present disclosure provides an apparatus and a method for detecting a traffic flow obstruction target to enhance the accuracy of detecting the traffic flow obstruction target. The accuracy of detecting a traffic flow obstruction target may be enhanced with regard to (i.e., by using) other pieces of information in an overall manner other than a speed of a separate vehicle.

Another aspect of the present disclosure provides an apparatus and a method for detecting a traffic flow obstruction target to set a bypass path based on the detected target to ensure stability of autonomous driving.

Another aspect of the present disclosure provides an apparatus and a method for detecting a traffic flow obstruction target to provide autonomous driving capable of suitably coping with a vehicle parked and stopped on a shoulder, a vehicle which invades the line, a vehicle which attempts to narrow and enter an interval with a forward vehicle at an intersection, an accident section, a construction section, a bicycle or pedestrian situation on an end lane, or the like.

The technical problems to be solved by the present disclosure are not limited to the aforementioned problems. Any other technical problems not mentioned herein should be clearly understood from the following description by those having ordinary skill in the art to which the present disclosure pertains.

According to an aspect of the present disclosure, an apparatus for detecting a traffic flow obstruction target is provided. The apparatus may include: a memory storing high definition map information; a sensor device provided in an autonomous vehicle to detect information about at least one of a speed of another vehicle, a driving path of the other vehicle, or a position of the other vehicle; and a processor that calculates a degree to which the other vehicle interferes with traffic flow, based on the at least one of the speed of the other vehicle, the driving path of the other vehicle, or the position of the other vehicle and based on the high definition map information and that selects the traffic flow obstruction target, based on the degree to which the other vehicle interferes with the traffic flow.

In an embodiment, the processor may calculate the degree to which the other vehicle interferes with the traffic flow with regard to at least one of an average speed according to a lane to which the other vehicle belongs, an average distance between vehicles according to the lane, or the number of vehicles occupying a reference distance section of the lane.

In an embodiment, the processor may calculate the degree to which the other vehicle interferes with the traffic flow with regard to information about a lane based on a lane link, a lane side, or a control path. The lane may be identified by means of the high definition map information.

In an embodiment, the processor may calculate the degree to which the other vehicle interferes with the traffic flow with regard to a driving path of a surrounding vehicle around the other vehicle.

In an embodiment, the processor may calculate the degree to which the other vehicle interferes with the traffic flow with regard to a driving intention of the other vehicle. The driving intention may be determined based on a history of a driving state of the other vehicle.

In an embodiment, the processor may determine the driving intention of the other vehicle by applying the history of the driving state of the other vehicle to a predetermined finite state machine.

In an embodiment, the processor may calculate the degree to which the other vehicle interferes with the traffic flow, based on a position of the other vehicle with respect to a predetermined point which interferes with traffic flow.

In an embodiment, the apparatus may further include a camera device that obtains an image of the other vehicle. The processor may calculate the degree to which the other vehicle interferes with the traffic flow with regard to at least one of whether a lamp of the other vehicle is turned on or whether there is a passenger in the other vehicle, which is determined by means of the image of the other vehicle.

In an embodiment, the apparatus may further include a communication device that obtains information about the other vehicle through vehicle-to-everything (V2X) communication. The processor may calculate the degree to which the other vehicle interferes with the traffic flow with regard to at least one of a lighting state of a lamp, a starting state, or a state of a brake, which is included in the information about the other vehicle.

In an embodiment, the processor may calculate the degree to which the other vehicle interferes with the traffic flow, based on a value determined by assigning a weight to a value including at least one of a value calculated based on information about a lane, a value calculated based on a driving path of a surrounding vehicle around the other vehicle, a value calculated based on a history of a driving state of the other vehicle, a value calculated based on a position of the other vehicle with respect to a predetermined point which interferes with traffic flow, a value calculated based on an image obtained by means of a camera, or a value calculated based on information obtained through V2X communication.

According to another aspect of the present disclosure, a method for detecting a traffic flow obstruction target is provided. The method may include: detecting, by a sensor device provided in an autonomous vehicle, information about at least one a speed of another vehicle, a driving path of the other vehicle, or a position of the other vehicle; calculating, by a processor, a degree to which the other vehicle interferes with traffic flow, based on the at least one of the speed of the other vehicle, the driving path of the other vehicle, or the position of the other vehicle and based on high definition map information stored in a memory; and selecting, by the processor, the traffic flow obstruction target, based on the degree to which the other vehicle interferes with the traffic flow.

In an embodiment, the calculating of the degree to which the other vehicle interferes with the traffic flow by the processor may include calculating, by the processor, the degree to which the other vehicle interferes with the traffic flow with regard to at least one of an average speed according to a lane to which the other vehicle belongs, an average distance between vehicles according to the lane, or the number of vehicles occupying a reference distance section of the lane.

In an embodiment, the calculating of the degree to which the other vehicle interferes with the traffic flow by the processor may include calculating, by the processor, the degree to which the other vehicle interferes with the traffic flow with regard to information about a lane based on a lane link, a lane side, or a control path. The lane may be identified by means of the high definition map information.

In an embodiment, the calculating of the degree to which the other vehicle interferes with the traffic flow by the processor may include calculating, by the processor, the degree to which the other vehicle interferes with the traffic flow with regard to a driving path of a surrounding vehicle around the other vehicle.

In an embodiment, the calculating of the degree to which the other vehicle interferes with the traffic flow by the processor may include calculating, by the processor, the degree to which the other vehicle interferes with the traffic flow with regard to a driving intention of the other vehicle. The driving intention may be determined based on a history of a driving state of the other vehicle.

In an embodiment, the calculating of the degree to which the other vehicle interferes with the traffic flow with regard to the driving intention of the other vehicle, by the processor may include determining, by the processor, the driving intention of the other vehicle by applying the history of the driving state of the other vehicle to a predetermined finite state machine.

In an embodiment, the calculating of the degree to which the other vehicle interferes with the traffic flow by the processor may include calculating, by the processor, the degree to which the other vehicle interferes with the traffic flow, based on a position of the other vehicle with respect to a predetermined point which interferes with traffic flow.

In an embodiment, the method may further include obtaining, by a camera device, an image of the other vehicle. The calculating of the degree to which the other vehicle interferes with the traffic flow by the processor may include calculating, by the processor, the degree to which the other vehicle interferes with the traffic flow with regard to at least one of whether a lamp of the other vehicle is turned on or whether there is a passenger in the other vehicle, which is determined by means of the image of the other vehicle.

In an embodiment, the method may further include obtaining, by a communication device, information about the other vehicle through V2X communication. The calculating of the degree to which the other vehicle interferes with the traffic flow by the processor may include calculating, by the processor, the degree to which the other vehicle interferes with the traffic flow, with regard to at least one of a lighting state of a lamp, a starting state, or a state of a brake, which is included in the information about the other vehicle.

In an embodiment, the calculating of the degree to which the other vehicle interferes with the traffic flow by the processor may include calculating, by the processor, the degree to which the other vehicle interferes with the traffic flow, based on a value determined by assigning a weight to a value including at least one of a value calculated based on information about a lane, a value calculated based on a driving path of a surrounding vehicle around the other vehicle, a value calculated based on a history of a driving state of the other vehicle, a value calculated based on a position of the other vehicle with respect to a predetermined point which interferes with traffic flow, a value calculated based on an image obtained by means of a camera, or a value calculated based on information obtained through V2X communication.

### BRIEF DESCRIPTION OF THE DRAWINGS

The above and other objects, features, and advantages of the present disclosure should be more apparent from the following detailed description taken in conjunction with the accompanying drawings:

FIG. 1 is a block diagram illustrating an apparatus for detecting a traffic flow obstruction target according to an embodiment of the present disclosure;

FIG. 2 is a block diagram illustrating an apparatus for detecting a traffic flow obstruction target according to another embodiment of the present disclosure;

FIG. 3 is a drawing illustrating a detailed configuration and operation of an apparatus for detecting a traffic flow obstruction target according to an embodiment of the present disclosure;

FIG. 4 is a flowchart illustrating an operation of an apparatus for detecting a traffic flow obstruction target according to an embodiment of the present disclosure;

FIG. 5 is a drawing illustrating a virtual line based on a lane link according to an embodiment of the present disclosure;

FIG. 6 is a drawing illustrating a lane side-based line, a lane link-based line, and a control path-based line according to an embodiment of the present disclosure;

FIG. 7 is a flowchart illustrating a process of selecting a virtual line in an apparatus for detecting a traffic flow obstruction target according to an embodiment of the present disclosure;

FIG. 8 is a drawing illustrating calculating a degree to which another vehicle interferes with traffic flow based on traffic flow according to a lane in an apparatus for detecting a traffic flow obstruction target according to an embodiment of the present disclosure;

FIG. 9 is a drawing illustrating calculating a degree to which another vehicle interferes with traffic flow, with regard to a driving path of a surrounding vehicle around the other vehicle in an apparatus for detecting a traffic flow obstruction target according to an embodiment of the present disclosure;

FIG. 10 is a drawing illustrating a finite state machine according to an embodiment of the present disclosure;

FIG. 11 is a drawing illustrating calculating a degree to which another vehicle interferes with traffic flow, based on a position of the other vehicle with respect to a point which interferes with traffic flow in an apparatus for detecting a traffic flow obstruction target according to an embodiment of the present disclosure;

FIG. 12 is a drawing illustrating calculating a final degree to which another vehicle interferes with traffic flow in an apparatus for detecting a traffic flow obstruction target according to an embodiment of the present disclosure; and

FIG. 13 is a flowchart illustrating a method for detecting a traffic flow obstruction target according to an embodiment of the present disclosure.

### DETAILED DESCRIPTION

Hereinafter, some embodiments of the present disclosure are described in detail with reference to the drawings. In adding the reference numerals to the components of each drawing, it should be noted that the identical or equivalent component is designated by the identical numeral even when they are displayed on other drawings. Further, in describing the embodiments of the present disclosure, a detailed description of well-known features or functions has been omitted in order not to unnecessarily obscure the gist of the present disclosure.

In describing the components of the embodiments according to the present disclosure, terms such as first, second, “A”, “B”, (a), (b), and the like may be used. These terms are merely intended to distinguish one component from another component. The terms do not limit the nature, sequence, or order of the constituent components. Furthermore, unless otherwise defined, all terms used herein, including technical or scientific terms, have the same meanings as those generally understood by those having ordinary skill in the art to which the present disclosure pertains. Such terms as those defined in a generally used dictionary are to be interpreted as having meanings consistent with the contextual meanings in the relevant field of art. Such terms are not to be interpreted as having ideal or excessively formal meanings unless clearly defined as having such in the present application. When a component, device, element, or the like of the present disclosure is described as having a purpose or performing an operation, function, or the like, the component, device, or element should be considered herein as being “configured to” meet that purpose or perform that operation or function.

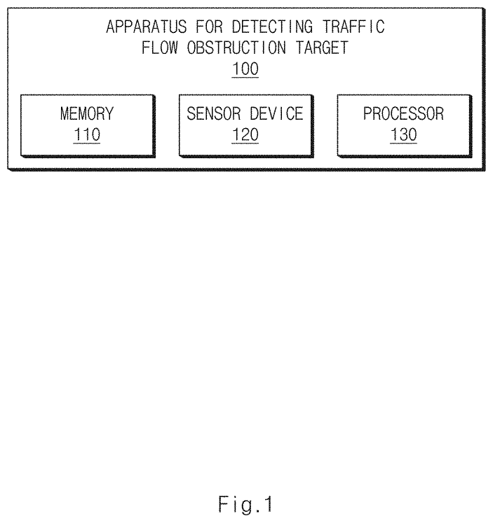

Hereinafter, embodiments of the present disclosure are described in detail with reference to FIGS. 1-13.

FIG. 1 is a block diagram illustrating an apparatus for detecting a traffic flow obstruction target (i.e., something obstructing/interfering with a flow of traffic) according to an embodiment of the present disclosure.

Referring to FIG. 1, an apparatus 100 for detecting a traffic flow obstruction target may include a memory 110, a sensor device 120, and a processor 130.

The apparatus 100 for detecting the traffic flow obstruction target according to an embodiment of the present disclosure may be implemented inside or outside a vehicle. In this case, the apparatus 100 for detecting the traffic flow obstruction target may be integrally configured with control units in the vehicle or may be implemented as a separate hardware device to be connected with the control units of the vehicle by a connection means.

As an example, the apparatus 100 for detecting the traffic flow obstruction target may be integrally configured with the vehicle or may be implemented in a configuration independent of the vehicle in the form of being installed/attached to the vehicle. Alternatively, a part of the apparatus 100 for detecting the traffic flow obstruction target may be integrally configured with the vehicle and the other part may be implemented as a configuration independent of the vehicle in the form of being installed/attached to the vehicle.

The memory 110 may store high definition map information.

The memory 110 may include at least one type of storage medium, such as a flash memory type memory, a hard disk type memory, a micro type memory, a card type memory (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic RAM (MRAM), a magnetic disk, and an optical disk.

As an example, the memory 110 may be connected with the processor 130 and may be configured such that the processor 130 accesses the memory 110 to use the stored information.

The sensor device 120 may be provided in an autonomous vehicle and may sense information about at least one of a speed of another vehicle, a driving path of the other vehicle, or a position of the other vehicle.

As an example, the sensor device 120 may include a light detection and ranging (LiDAR), a radar, and a camera.

The sensor device 120 may sense information of another vehicle, which is present around the autonomous vehicle, by means of the LiDAR, the radar, and the camera, and may deliver the sensed information to the processor 130.

As an example, the sensor device 120 may be connected with the processor 130 through wireless or wired communication to directly or indirectly deliver the sensed information to the processor 130.

The processor 130 may be electrically connected with the memory 110, the sensor device 120, or the like and may electrically control the respective components. The processor 130 may be an electrical circuit, which executes instructions of software and may perform a variety of data processing and calculation described below.

The processor 130 may calculate a degree to which another vehicle interferes with traffic flow, based on at least one of a speed of the other vehicle, a driving path of the other vehicle, or a position of the other vehicle and based on high definition map information.

As an example, the processor 130 may calculate a degree to which another vehicle interferes with traffic flow, depending on a predetermined scheme (e.g., a predetermined formula, equation, model, or the like), based on at least one of a speed of the other vehicle, a driving path of the other vehicle, or a position of the other vehicle and based on high definition map information.

The processor 130 may select a traffic flow obstruction target, based on the degree to which the other vehicle interferes with the traffic flow.

As an example, when a score for the calculated degree to which the other vehicle interferes with the traffic flow is greater than a predetermined threshold, the processor 130 may select (e.g., identify) the other vehicle as a traffic flow obstruction target.

As an example, the processor 130 may calculate a degree to which another vehicle interferes with traffic flow with regard to at least one of an average speed according to a lane to which the other vehicle belongs, an average distance between vehicles according to the lane, or the number of vehicles occupying a reference distance interval of the lane.

As an example, the processor 130 may identify traffic flow of a lane to which another vehicle belongs, with respect to an average speed of the lane, an average distance between vehicles on the lane, the number of vehicles occupying a reference distance interval of the lane, or the like.

Illustratively, as the average speed of the lane to which the other vehicle belongs is lower (i.e., slower), as the average distance between vehicles is shorter (i.e., less), and as there are more vehicles occupying the reference distance interval of the lane, the processor 130 may determine that the traffic flow of the lane is more congested.

In this case, the processor 130 may calculate a score for the degree to which the other vehicle occupying the lane interferes with the traffic flow to be high.

On the other hand, as the average speed of the lane to which the other vehicle belongs is higher (i.e., faster), as the average distance between vehicles is longer (i.e., greater), and as there are less vehicles occupying the reference distance interval of the lane, the processor 130 may determine that the traffic flow of the lane is more smooth (e.g., less congested).

In this case, the processor 130 may calculate a score for the degree to which the other vehicle occupying the lane interferes with the traffic flow to be low.

As an example, the processor 130 may calculate a degree to which another vehicle interferes with traffic flow with regard to information about a lane based on a lane link, a lane side, or a control path, which is identified by means of the high definition map information.

The lane based on the lane link may refer to a lane, the width of which is constant with respect to a path where the center of the vehicle is traveling.

The lane based on the lane side may refer to a lane with respect to a predetermined line.

The lane based on the control path may be a lane considering a driving strategy, which may be calculated in real time according to a path where the vehicle is controlled.

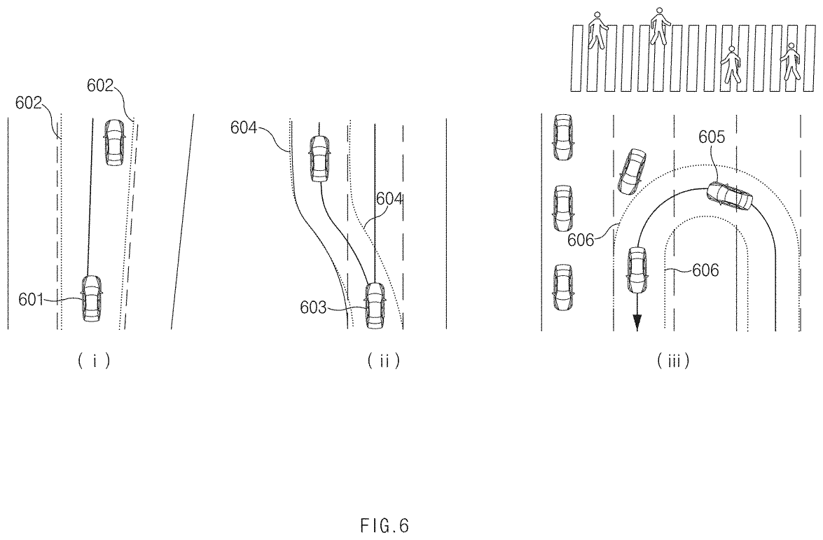

A detailed description is given below of the lane based on the lane link, the lane side, or the control path with reference to FIG. 6.

As an example, the processor 130 may apply a lane suitable for each situation, among lanes based on a lane link, a lane side, or a control path, which are identified by means of high definition map information. The processor 130 may calculate a score for a degree to which another vehicle interferes with traffic flow, based on traffic flow for each applied lane.

As an example, the processor 130 may calculate a degree to which another vehicle interferes with traffic flow with regard to a driving path of a surrounding vehicle around the other vehicle.

When the other vehicle interferes with the traffic flow, a surrounding vehicle around the other vehicle may bypass (e.g., avoid or detour around) the other vehicle to travel.

The processor 130 may determine whether the surrounding vehicle around the other vehicle bypasses the other vehicle to travel, by means of the driving path of the surrounding vehicle around the other vehicle.

When it is determined that the surrounding vehicle around the other vehicle bypasses the other vehicle to travel, the processor 130 may calculate a score for a degree to which the other vehicle interferes with traffic flow to be high. When it is determined that the surrounding vehicle around the other vehicle does not bypass the other vehicle to travel, the processor 130 may calculate a score for a degree to which the other vehicle interferes with traffic flow to be low.

In the process, the processor 130 may obtain information about the driving path of the surrounding vehicle around the other vehicle, by means of the sensor device 120.

As another example, the processor 130 may obtain information about the driving path of the surrounding vehicle around the other vehicle, by means of vehicle-to-everything (V2X) communication.

As an example, the processor 130 may calculate a degree to which another vehicle interferes with traffic flow with regard to a driving intention of the other vehicle, which is determined based on a history of a driving state of the other vehicle.

As an example, the processor 130 may calculate a score for a degree to which another vehicle interferes with traffic flow, depending on a state corresponding to a driving intention of the other vehicle, which is determined based on a history of a driving state of the other vehicle.

In detail, the processor 130 may determine the fact such as past driving, deceleration, acceleration, or stopping of the other vehicle by means of the history of the driving state of the other vehicle.

Particularly, the processor 130 may determine a driving intention of the other vehicle based on a current state with regard to a history where the other vehicle transitions from a specific state to another state through driving, deceleration, acceleration, or stopping.

The state of the other vehicle may be determined as one of a number of predetermined states. As an example, the predetermined states of the other vehicle may include a driving state, a deceleration state, a short-term stop state, and a long-term stop state.

As an example, the processor 130 may apply a history of a driving state of another vehicle to a finite state machine to determine a driving intention of the other vehicle.

As an example, the finite state machine may define a state transition of the other vehicle according to a specific event with respect to the states of the other vehicle, including the driving state, the deceleration state, the short-term stop state, and the long-term stop state.

As an example, the specific event corresponding to the state transition of the other vehicle may include a start of driving, stopping, deceleration, acceleration, and the like.

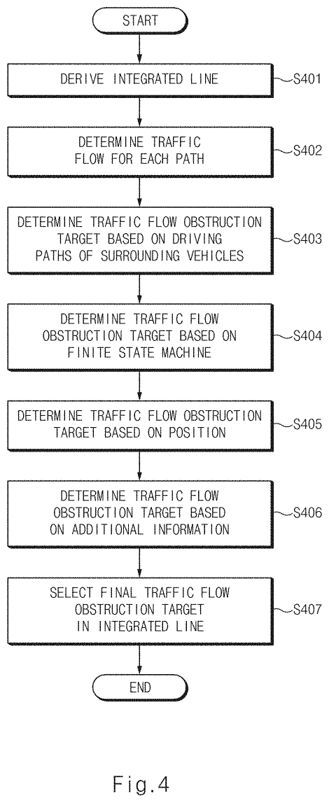

A description is given below of one example of the finite state machine with reference to FIG. 4.

As an example, the processor 130 may calculate a degree to which another vehicle interferes with traffic flow, based on a position of the other vehicle with respect to a predetermined point which interferes with traffic flow (i.e., the predetermined interference point or location).

In the road situation, traffic flow may be congested in the vicinity of a bus stop, a taxi stand, a road construction area, an accident point, or the like.

Thus, the predetermined point, which interferes with the traffic flow may include a bus stop, a taxi stand, a road construction area, an accident point, or the like capable of causing congestion of traffic flow.

The processor 130 may calculate a score for a degree to which another vehicle interferes with traffic flow, depending on a longitudinal position of the other vehicle with respect to the predetermined point, which interferes with the traffic flow.

The closer the longitudinal distance to the predetermined point, which interferes with the traffic flow, the larger the degree to which the other vehicle interferes with the traffic flow. Thus, as the longitudinal distance to the predetermined point, which interferes with the traffic flow is closer (i.e., shorter or less), the processor 130 may calculate a score for a degree to which another vehicle interferes with traffic flow to be higher.

On the other hand, the more distant the longitudinal distance to the predetermined point, which interferes with the traffic flow, the smaller the degree to which the other vehicle interferes with the traffic flow. Thus, as the longitudinal distance to the predetermined point, which interferes with the traffic flow is more distant (i.e., further or more), the processor 130 may calculate a score for a degree to which another vehicle interferes with traffic flow to be lower.

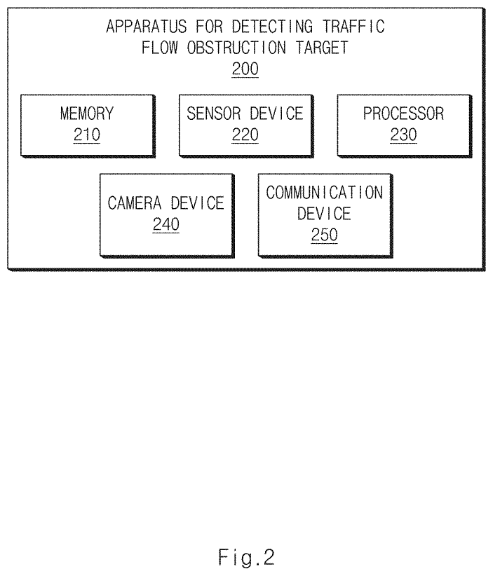

FIG. 2 is a block diagram illustrating an apparatus for detecting a traffic flow obstruction target according to another embodiment of the present disclosure.

Referring to FIG. 2, an apparatus 200 for detecting a traffic flow obstruction target may include a memory 210, a sensor device 220, a processor 230, a camera device 240, and a communication device 250.

The memory 210, the sensor device 220, and the processor 230 included in the apparatus 200 for detecting the traffic flow obstruction target may include all of the features described for a memory 110, a sensor device 120, and a processor 130 included in an apparatus 100 for detecting a traffic flow obstruction target in FIG. 1. Thus, the memory 210, the sensor device 220, and the processor 230 may be understood as further including features described with reference to FIG. 2 other than the features described for the memory 110, the sensor device 120, and the processor 130 of FIG. 1.

The processor 230 may be electrically connected with the memory 210, the sensor device 220, the camera device 240, the communication device 250, or the like and may electrically control the respective components. The processor 230 may be or have an electrical circuit, which executes instructions of software and may perform a variety of data processing and calculation described below.

The camera device 240 may obtain an image of another vehicle.

The camera device 240 may include one or more cameras, which obtain an image around an autonomous vehicle.

As an example, the camera device 240 may include a surround view monitor (SVM) camera, a digital video recording system (DVRS) camera, a camera monitor system (CMS) camera, or a line detection camera of the vehicle.

As an example, the camera device 240 may deliver the obtained image to the processor 230.

The processor 230 may calculate a degree to which another vehicle interferes with traffic flow with regard to at least one of whether a lamp of the other vehicle is turned on or whether there is a passenger in the other vehicle, which is determined by means of an image of the other vehicle.

As an example, the processor 230 may determine whether a lamp such as a vehicle tail light, a turn signal, or a hazard light of the other vehicle is turned on by means of an image of the other vehicle.

Furthermore, the processor 230 may recognize a passenger in the other vehicle by means of an image of the other vehicle to determine whether there is the passenger in the other vehicle.

For example, when the lamp such as the vehicle tail light, the turn signal, or the hazard light of the other vehicle is turned on, there may be a high probability that the other vehicle will be in a parked or stopped state and a degree to which the other vehicle interferes with traffic flow may be high. Thus, the processor 230 may calculate a score corresponding to the degree to which the other vehicle interferes with the traffic flow, with regard to whether the lamp such as the vehicle tail light, the turn signal, or the hazard light is turned on.

Furthermore, when there is no passenger in the other vehicle, there may be a high probability that the other vehicle will be in a parked or stopped state and the degree to which the other vehicle interferes with the traffic flow may be high. Thus, the processor 230 may calculate a score corresponding to the degree to which the other vehicle interferes with the traffic flow with regard to whether there is the passenger in the other vehicle.

The communication device 250 may obtain information about the other vehicle through V2X communication.

The V2X communication may include vehicle to infrastructure (V2I) communication, vehicle to vehicle (V2V) communication, and vehicle to nomadic devices (V2N) communication.

Information about the other vehicle, which is obtained through V2X communication by the communication device 250, may include at least one of a lighting state of the lamp, a starting state, or a state of the brake, which is included in the information about the other vehicle.

As an example, the communication device 250 may deliver the information about the other vehicle to the processor 230.

The processor 230 may calculate a degree to which another vehicle interferes with traffic flow with regard to at least one of the lighting state of the lamp, the starting state, or the state of the brake, which is included in the information about the other vehicle.

For example, when the lamp such as the hazard light of the other vehicle is turned on, the other vehicle is turned off, or when the parking brake (a side brake) of the other vehicle is locked, because there may be a high probability that the other vehicle will be parked or stopped, the processor 230 may calculate a score corresponding to a degree to which the other vehicle interferes with traffic flow with regard to at least one of a lighting state of the lamp of the other vehicle, a starting state, or a state of the brake.

As an example, the processor 230 may divide a classification, i.e., a category or step, where the other vehicle interferes with traffic flow into three classes, i.e., categories or steps, and may calculate a score corresponding to each class, i.e., category or step. The processor 230 may calculate the score by means of the image obtained by the camera device 240 and the information obtained by means of the communication device 250.

Illustratively, the processor 230 may classify the case where the other vehicle is turned off, where the side brake is locked, or where there is no passenger in the other vehicle as class 3, may classify the case where the other vehicle is able to start, but is stopped as class 2, and may classify the other as class 1.

After dividing the classification, the processor 230 may calculate a final score by adding 3 points to a score corresponding to the previously calculated degree to which the other vehicle interferes with the traffic flow in class 3, adding 2 points to the score in class 2, and adding 1 point to the score in step 1, depending on another factor.

Herein, dividing the classification into the three classes and assigning the score corresponding to each class is 3 points, 2 points, or 1 point are randomly set in order to give an example. However, the classes and scores may in practice be set differently.

As an example, the processor 230 may calculate a degree to which another vehicle interferes with traffic flow, based on a value determined by assigning a weight to a value including at least one of: a value calculated based on information about a lane; a value calculated based on a driving path of a surrounding vehicle around the other vehicle; a value calculated based on a history of a driving state of the other vehicle; a value calculated based on a position of the other vehicle with respect to a predetermined point, which interferes with traffic flow; a value calculated based on an image obtained by means of a camera; or a value calculated based on information obtained through V2X communication.

As an example, the processor 230 may calculate a score, determined by assigning a weight to scores calculated by a plurality of criteria for determining a degree to which the other vehicle interferes with traffic flow as a final score corresponding to the degree to which the other vehicle interferes with the traffic flow.

The weight may be a parameter, which may be differently assigned to each criterion and may be tuned (e.g., adjusted), depending on importance. Furthermore, the weight may be determined as an optimal value by means of an experimental method (e.g., experimentation).

Illustratively, it may be determined that a method for recognizing whether the other vehicle is parked or stopped for the first time by means of a driving speed of the other vehicle is associated with a method based on a history of a driving state of the other vehicle. Further, it may be determined that determining or recognizing whether a vehicle is parked or stopped based on a position of the other vehicle is frequently performed to determine whether the other vehicle is stopped on a shoulder or whether the other vehicle is waiting for a left turn/right turn. Further, it may be determined that traffic flow for each lane or driving paths of surrounding vehicles are unable to be simply applied as an aspect of interaction between vehicles, or that additional information obtained by means of a camera image or V2X communication is not always able to be used to determine whether a vehicle is parked or stopped.

In these cases, a high weight may be assigned in an order of a value calculated based on a history of a driving state of the other vehicle, a value calculated based on a position of the other vehicle with respect to a predetermined point which interferes with traffic flow, a value calculated based on information about a lane, a value calculated based on a driving path of a surrounding vehicle around the other vehicle, a value calculated based on an image obtained by means of the camera, or a value calculated based on information obtained through V2X communication.

Herein, such an order is only to give an example. According to an embodiment, a high weight may be assigned in a different order.

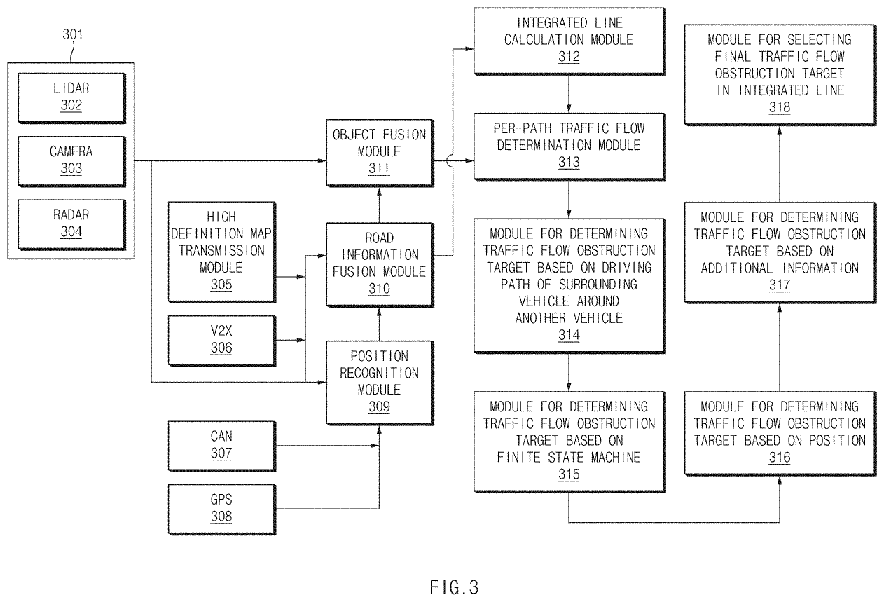

FIG. 3 is a drawing illustrating a detailed configuration and operation of an apparatus for detecting a traffic flow obstruction target according to an embodiment of the present disclosure.

Referring to FIG. 3, a sensor device 301 may include a LiDAR 302, a camera 303, and a radar 304.

Recognition information about another vehicle, which is obtained by means of the LiDAR 302, the camera 303, and the radar 304 of the sensor device 301 may be transmitted to an object fusion module 311 and a position recognition module 309.

A high definition map transmission module 305 may transmit information about a high definition map around an autonomous vehicle to a road information fusion module 310 and the position recognition module 309.

A V2X 306 may transmit information about the other vehicle, which is obtained through V2X communication, to the road information fusion module 310 and the position recognition module 309.

The position recognition module 309 may be communicatively connected with a controller area network (CAN) 307 of the autonomous vehicle to perform a communication function and may be connected with a global positioning system (GPS) 308 of the autonomous vehicle to obtain position information of the autonomous vehicle.

The position recognition module 309 may compare the recognition information obtained by means of the sensor device 301, the information obtained by means of the GPS 308, and the high definition map information transmitted from the high definition map transmission module 305. The position recognition module 309 may output position information of the autonomous vehicle and reliability of position recognition together to be transmitted to the road information fusion module 310.

The road information fusion module 310 may output high definition map information around the autonomous vehicle, by means of the position recognition information and the high definition map information to be transmitted to the object fusion module 311 and an integrated line calculation module 312.

The object fusion module 311 may fuse (e.g., merge, combine, join) information transmitted to the object fusion module 311 and output an object on a high definition map. The object fusion module 311 may output an object on a high definition map by means of the recognition information obtained by means of the sensor device 301 and the high definition map information around the autonomous vehicle, which is received from the road information fusion module 310. The object fusion module 311 may transmit the output information to a per-path traffic flow determination module 313.

As an example, the object may include another vehicle around the autonomous vehicle.

The integrated line calculation module 312 may derive a virtual line based on a lane link, a lane side, or a control path, depending on a current driving situation of the autonomous vehicle, and may transmit information about the derived virtual line to the per-path traffic flow determination module 313.

The per-path traffic flow determination module 313 may calculate a degree to which another vehicle interferes with traffic flow with regard to an average speed of vehicles located in each lane on a high definition map and may transmit the calculated value to a module 314 for determining a traffic flow obstruction target based on a driving path of a surrounding vehicle around the other vehicle.

The module 314 for determining the traffic flow obstruction target based on the driving path of the surrounding vehicle around the other vehicle may calculate a degree to which the other vehicle interferes with traffic flow based on whether driving paths of surrounding vehicles around the other vehicle are changed by the other vehicle. The module 314 may transmit the calculated value to a module 315 for determining a traffic flow obstruction target based on a finite state machine.

The module 315 for determining the traffic flow obstruction target based on the finite state machine may track a driving state transition and a driving state history of the other vehicle to calculate a degree to which the other vehicle interferes with traffic flow. The module 315 may transmit the calculated value to a module 316 for determining a traffic flow obstruction target based on a position.

The module 316 for determining the traffic flow obstruction target based on the position may calculate a degree to which another vehicle interferes with traffic flow based on whether a current position of the other vehicle is a place having a high tendency to cause congestion in actual traffic flow. The module 316 may transmit the calculated value to a module 317 for determining a traffic flow obstruction target based on additional information.

The module 317 for determining the traffic flow obstruction target based on the additional information may calculate a degree to which another vehicle interferes with traffic flow, using additional information obtained by means of a camera, V2X, and the like. The module 317 may transmit the calculated value to a module 318 for selecting a final traffic flow obstruction target in an integrated line.

The module 318 for selecting the final traffic flow obstruction target in the integrated line may finally determine whether another vehicle interferes with traffic flow, in overall combination of degrees to which the other vehicle interferes with traffic flow, which are calculated by means of other modules, to select a traffic flow obstruction target.

The components of 309-318 of FIG. 3 may be implemented by means of a processor 130 or 230 of FIG. 1 or 2, and each module may be implemented in the form of software or hardware.

FIG. 4 is a flowchart illustrating an operation of an apparatus for detecting a traffic flow obstruction target according to an embodiment of the present disclosure.

Referring to FIG. 4, in S401, an apparatus 100 or 200 for detecting a traffic flow obstruction target may derive an integrated line.

Herein, the integrated line may refer to a line obtained by using a line selected according to a situation among a lane link-based line, a lane side-based line, or a control path-based line.

After deriving the integrated line in S401, in S402, the apparatus 100 or 200 for detecting the traffic flow obstruction target may determine traffic flow for each path.

As an example, the apparatus 100 or 200 for detecting the traffic flow obstruction target may determine traffic flow for each path, including an average speed of a lane to which the other vehicle belongs, an average distance between vehicles on the lane, the number of vehicles occupying a reference distance section of the lane, or the like. The apparatus 100 or 200 may calculate a degree to which the other vehicle interferes with traffic flow, depending on the traffic flow for each path.

After determining the traffic flow for each path in S402, in S403, the apparatus 100 or 200 for detecting the traffic flow obstruction target may determine a traffic flow obstruction target based on driving paths of surrounding vehicles.

As an example, the apparatus 100 or 200 for detecting the traffic flow obstruction target may determine whether surrounding vehicles around another vehicle bypass the other vehicle to travel by means of driving paths of the surrounding vehicle around the other vehicle. The apparatus 100 or 200 may calculate a degree to which the other vehicle interferes with traffic flow based on whether the surrounding vehicles bypass the other vehicle to travel.

After determining the traffic flow obstruction target based on the driving paths of the surrounding vehicles in S403, in S404, the apparatus 100 or 200 for detecting the traffic flow obstruction target may determine the traffic flow obstruction target based on the finite state machine.

As an example, the apparatus 100 or 200 for detecting the traffic flow obstruction target may apply a history of a driving state of the other vehicle to a predetermined finite state machine to calculate a degree to which the other vehicle interferes with traffic flow.

In other words, the degree to which the other vehicle interferes with the traffic flow may correspond to a driving state and/or a driving history of the other vehicle.

After determining the traffic flow obstruction target based on the finite state machine in S404, in S405, the apparatus 100 or 200 for detecting the traffic flow obstruction target may determine the traffic flow obstruction target based on the position of the other vehicle.

As an example, the apparatus 100 or 200 for detecting the traffic flow obstruction target may calculate a degree to which another vehicle interferes with traffic flow based on a distance from a predetermined point where the position of the other vehicle interferes with traffic flow to a reference point.

After determining the traffic flow obstruction target based on the position of the other vehicle in S405, in S406, the apparatus 100 or 200 for detecting the traffic flow obstruction target may determine the traffic flow obstruction target based on additional information.

As an example, the apparatus 100 or 200 for detecting the traffic flow obstruction target may determine whether there is a person in the other vehicle, whether the other vehicle is parked or stopped, or the like based on additional information about the other vehicle, which is identified by means of a camera, V2X communication, or the like. The apparatus 100 or 200 may calculate a degree to which the other vehicle interferes with traffic flow.

After determining the traffic flow obstruction target based on the additional information in S406, in S407, the apparatus 100 or 200 for detecting the traffic flow obstruction target may finally select a traffic flow obstruction target in an integrated line.

As an example, the apparatus 100 or 200 for detecting the traffic flow obstruction target may determine whether a value determined by applying a weight to a score calculated according to each determination criterion is greater than a specific threshold and may finally select a traffic flow obstruction target.

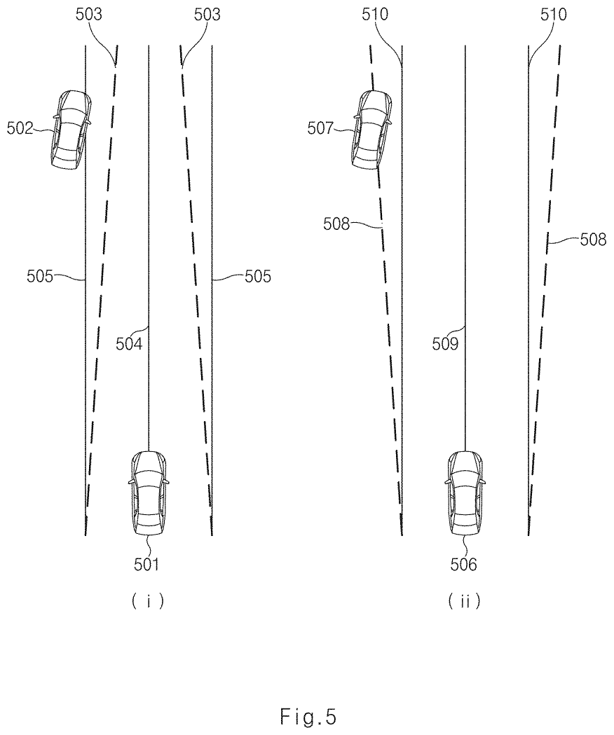

FIG. 5 is a drawing illustrating a virtual line based on a lane link according to an embodiment of the present disclosure.

Referring to FIG. 5, an apparatus 100 or 200 for detecting a traffic flow obstruction target in FIG. 1 or 2 may derive a lane link-based virtual line.

FIG. 5 at (i) illustrates a situation in which derived lane link-based lines 505 are wider in width than actual lines 503, with respect to an autonomous vehicle 501.

The apparatus 100 or 200 for detecting the traffic flow obstruction target may derive the lane link-based lines 505 using border lines at both ends of the road having a certain width on the basis of a driving path 504 around the autonomous vehicle 501.

In (i) of FIG. 5, another vehicle 502 invades the lane link-based line 505, but may fail to invade the actual line 503.

FIG. 5 at (ii) illustrates a situation in which derived lane link-based lines 510 are narrower in width than actual lines 508 with respect to an autonomous vehicle 506.

The apparatus 100 or 200 for detecting the traffic flow obstruction target may derive the lane link-based lines 510 using border lines at both ends of the road having a certain width on the basis of a driving path 509 around the autonomous vehicle 506.

In (ii) of FIG. 5, another vehicle 507 does not invade the lane link-based line 510 but may invade the actual line 508.

By means of such an example, it may be seen that it is accurate to calculate a degree to which another vehicle interferes with traffic flow by means of a lane side-based line rather than a lane link-based line in a section where the width of the lane is changed.

Thus, the apparatus 100 or 200 for detecting the traffic flow obstruction target may calculate a degree to which another vehicle interferes with traffic flow by means of a lane side-based virtual line in a section where the width of the lane is changed (e.g., around a toll gate on the highway, when the change in the width of the lane is not noticeable in the city center, but the change is large, or the like).

Thus, the apparatus 100 or 200 for detecting the traffic flow obstruction target may calculate a degree to which another vehicle interferes with traffic flow by means of a lane link-based virtual line in a section where the width of the lane is not changed (e.g., a section where the lane width is constant in the highway, a pocket lane, when the lane width is very large, or the like).

The apparatus 100 or 200 for detecting the traffic flow obstruction target may calculate a degree to which another vehicle interferes with traffic flow by means of a point-level path-based virtual line in a special section. A description of a point-level path-based virtual line in a special section is given below.

FIG. 6 is a drawing illustrating a lane side-based line, a lane link-based line, and a control path-based line according to an embodiment of the present disclosure.

FIG. 6 at (i) illustrates a lane side-based virtual line 602.

The lane side-based virtual line 602 may refer to a line in which an actual line on which an autonomous vehicle 601 travels is reflected.

When there is a line where the width of the lane is changed and when the autonomous vehicle 601 travels on the same line without changing the line, the lane side-based virtual line 602 may be useful.

FIG. 6 at (ii) illustrates a lane link-based virtual line 604.

The lane link-based virtual line 604 may refer to a virtual line connecting both ends of the lane having a certain width, with respect to a line connecting the center of an autonomous vehicle 603 as the autonomous vehicle 603 travels.

When the lane is excessively larger in width than the autonomous vehicle 603, when the autonomous vehicle 603 travels on a pocket road, and when the autonomous vehicle 603 makes a lane change, the lane link-based virtual line 604 may be useful.

FIG. 6 at (iii) illustrates a control path-based virtual line 606.

The control path-based virtual line 606 may refer to a point level path (PLP)-based line according to a control target path an autonomous vehicle 605 should follow for driving control.

The control path-based virtual line 606 may be useful in a situation where there is no actual line or when the vehicle is driving out of the line, for example, in a wide lane corresponding to the inside of an intersection, a left turn/a right turn, a P-turn, a U-turn, or a bus stop area.

As an example, when a control path for control following of the autonomous vehicle 605 is calculated from a previous frame, an apparatus 100 or 200 for detecting a traffic flow obstruction target in FIG. 1 or 2 may determine an in-path or deviation in a certain interval of a degree to which the autonomous vehicle 605 passes at the left and right of the control path.

As an example, because the control path is determined in the final step, the apparatus 100 or 200 for detecting the traffic flow obstruction target may use information of a previous frame. The apparatus 100 or 200 for detecting the traffic flow obstruction target may use a lane side-based virtual line or a lane link-based virtual line in a process where a driving strategy is not determined (e.g., a process of determining whether to make a lane change) or may postpone determination in the corresponding frame.

As an example, the apparatus 100 or 200 for detecting the traffic flow obstruction target may generate a virtual line considering a direction and range where the control path is changed in a situation where the control path is continuously changed (e.g., a situation where the path is corrected during a lane change or the like).

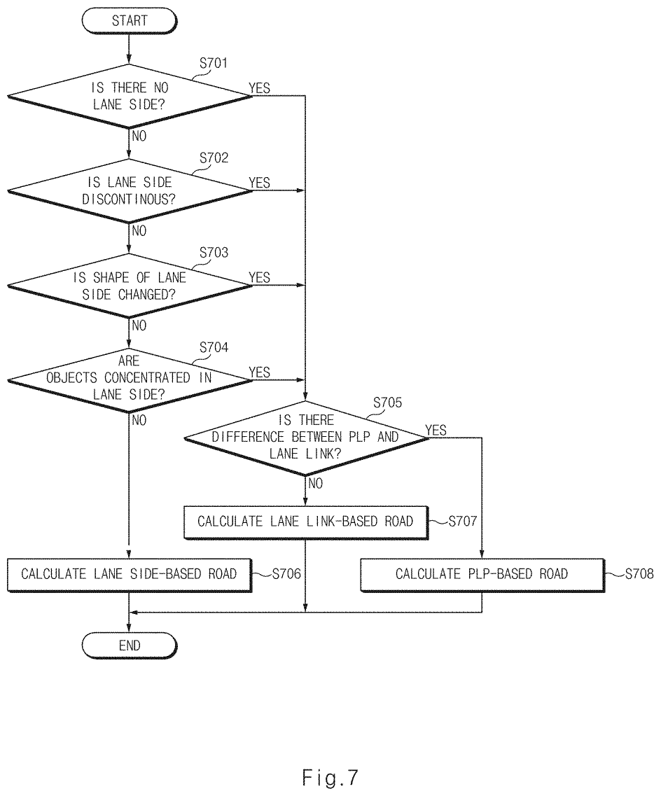

A description is given of the process for selecting a lane link-based virtual line, a lane side-based virtual line, or a control path-based virtual line in the apparatus 100 or 200 for detecting the traffic flow obstruction target with reference to FIG. 7.

FIG. 7 is a flowchart illustrating a process of selecting a virtual line in an apparatus for detecting a traffic flow obstruction target according to an embodiment of the present disclosure.

Referring to FIG. 7, in S701, an apparatus 100 or 200 for detecting a traffic flow obstruction target in FIG. 1 or 2 may identify whether there is no lane side.

As an example, the apparatus 100 or 200 for detecting the traffic flow obstruction target may identify whether there is no lane side, based on high definition map information or line information identified by means of a camera.

After identifying whether there is no lane side in S701, when it is identified that there is no lane side, in S705, the apparatus 100 or 200 for detecting the traffic flow obstruction target may identify whether there is a difference between a PLP and a lane link.

After identifying whether there is no lane side in S701, when it is identified that there is the lane side, in S702, the apparatus 100 or 200 for detecting the traffic flow obstruction target may identify whether the lane side is discontinuous.

As an example, the apparatus 100 or 200 for detecting the traffic flow obstruction target may identify whether the lane side is discontinuous based on high definition map information or line information identified by means of the camera.

After identifying whether the lane side is discontinuous in S702, when it is identified that lane side is discontinuous, in S705, the apparatus 100 or 200 for detecting the traffic flow obstruction target may identify whether there is a difference between the PLP and the lane link.

After identifying whether the lane side is discontinuous in S702, when it is identified that lane side is not discontinuous, in S703, the apparatus 100 or 200 for detecting the traffic flow obstruction target may identify whether the shape of the lane side is changed.

As an example, the apparatus 100 or 200 for detecting the traffic flow obstruction target may identify whether the shape of the lane side is changed based on high definition map information or line information identified by means of the camera.

After identifying whether the shape of the lane side is changed in S703, when it is identified that the shape of the lane side is changed, in S705, the apparatus 100 or 200 for detecting the traffic flow obstruction target may identify whether there is a difference between the PLP and the lane link.

After identifying whether the shape of the lane side is changed in S703, when it is identified that the shape of the lane side is not changed, in S704, the apparatus 100 or 200 for detecting the traffic flow obstruction target may identify whether objects are concentrated in the lane side.

As an example, when the objects are concentrated in the lane side, because the vehicle travels out of the line, the apparatus 100 or 200 for detecting the traffic flow obstruction target may fail to use a lane side-based road.

After identifying whether the objects are concentrated in the lane side in S704, when it is identified that the objects are concentrated in the lane side, in S705, the apparatus 100 or 200 for detecting the traffic flow obstruction target may identify whether there is a difference between the PLP and the lane link.

Basically, the apparatus 100 or 200 for detecting the traffic flow obstruction target may detect a traffic flow obstruction target using a lane side-/lane link-based line based on high definition map information. The apparatus 100 or 200 may detect a traffic flow obstruction target using a PLP-based line only in special cases.

After identifying whether the objects are concentrated in the lane side in S704, when it is identified that the objects are not concentrated in the lane side, in S706, the apparatus 100 or 200 for detecting the traffic flow obstruction target may calculate a lane side-based road.

As an example, the apparatus 100 or 200 for detecting the traffic flow obstruction target may give a top priority to calculating the lane side-based road and may calculate the lane side-based road when it is not a special case.

After identifying whether there is the difference between the PLP and the lane link in S705, when it is identified that there is no difference between the PLP and the lane link, in S707, the apparatus 100 or 200 for detecting the traffic flow obstruction target may calculate a lane link-based road.

As an example, the apparatus 100 or 200 for detecting the traffic flow obstruction target may give a priority to calculating the lane link-based road subsequent to calculating the lane side-based road. The apparatus 100 or 200 may calculate the lane link-based road when there is no difference between the PLP and the lane link.

After identifying whether there is the difference between the PLP and the lane link in S705, when it is identified that there is a difference between the PLP and the lane link, in S708, the apparatus 100 or 200 for detecting the traffic flow obstruction target may calculate a PLP-based road.

As an example, when the line is changed and when the lane link-based line and the control path-based line are different from each other, the apparatus 100 or 200 for detecting the traffic flow obstruction target may calculate a more accurate control path-based line.

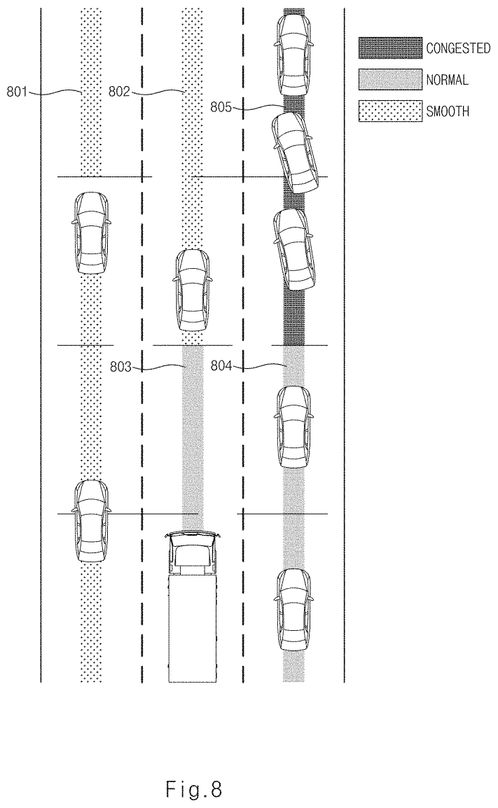

FIG. 8 is a drawing illustrating calculating a degree to which another vehicle interferes with traffic flow based on traffic flow according to a lane in an apparatus for detecting a traffic flow obstruction target according to an embodiment of the present disclosure.

Referring to FIG. 8, traffic flow may be smooth on lane 1 at a portion 801, there may be a portion 802 where traffic flow is smooth and a portion 803 where traffic flow is normal on lane 2, and there may be a portion 804 where traffic flow is normal and a portion 805 where traffic flow is congested on lane 3.

The lower the average speed of each lane, the shorter the average distance between vehicles. The higher the number of vehicles occupying a reference distance section of the lane, the higher a score, corresponding to a degree to which another vehicle which belongs to the lane interferes with traffic flow calculated by the apparatus 100 or 200 for detecting the traffic flow obstruction target, may be.

As an example, the apparatus 100 or 200 for detecting the traffic flow obstruction target may calculate a score corresponding to a degree to which the other vehicle interferes with traffic flow by means of a function where there is an increase in a value calculated in proportion to a degree to which the average speed is low, a degree to which the average distance between the vehicles is short, and the number of vehicles occupying the reference distance section.

When the vehicle occupying the lane is not identified, the apparatus 100 or 200 for detecting the traffic flow obstruction target may identify the speed limit of the vehicle according to the law (i.e., a posted speed limit) as an average speed of the lane.

Furthermore, the apparatus 100 or 200 for detecting the traffic flow obstruction target may determine a construction lane and an accident lane as roads corresponding to a congestion section without identifying vehicle information about the lanes.

The apparatus 100 or 200 for detecting the traffic flow obstruction target may calculate a score corresponding to a degree to which another vehicle interferes with traffic flow based on traffic flow of the road the other vehicle occupies rather than a separate speed of the other vehicle.

Illustratively, although the current speed of another vehicle, which is traveling on lane 3, is temporarily driving fast, when it is determined that lane 3 is determined as a congestion section because other vehicles on lane 3 are driving at slower speeds, the apparatus 100 or 200 for detecting the traffic flow obstruction target may determine that a degree to which the other vehicle interferes with traffic flow is high.

In this case, the apparatus 100 or 200 for detecting the traffic flow obstruction target may calculate a score corresponding to a degree to which the other vehicle, which belongs to lane 3, interferes with traffic flow as 10 points.

On the other hand, although the current speed of another vehicle, which is traveling on lane 1, is temporarily slow, when it is determined that lane 1 is determined as a section where traffic flow is smooth because other vehicles on lane 1 are driving at faster speeds, the apparatus 100 or 200 for detecting the traffic flow obstruction target may determine that a degree to which the other vehicle interferes with traffic flow is low.

In this case, the apparatus 100 or 200 for detecting the traffic flow obstruction target may calculate a score corresponding to a degree to which the other vehicle, which belongs to lane 1, interferes with traffic flow as 2 points.

Herein, scores such as 10 points and 2 points may be an example randomly determined to relatively compare scores according to traffic flow. However, such scores in practice may be or have different values.

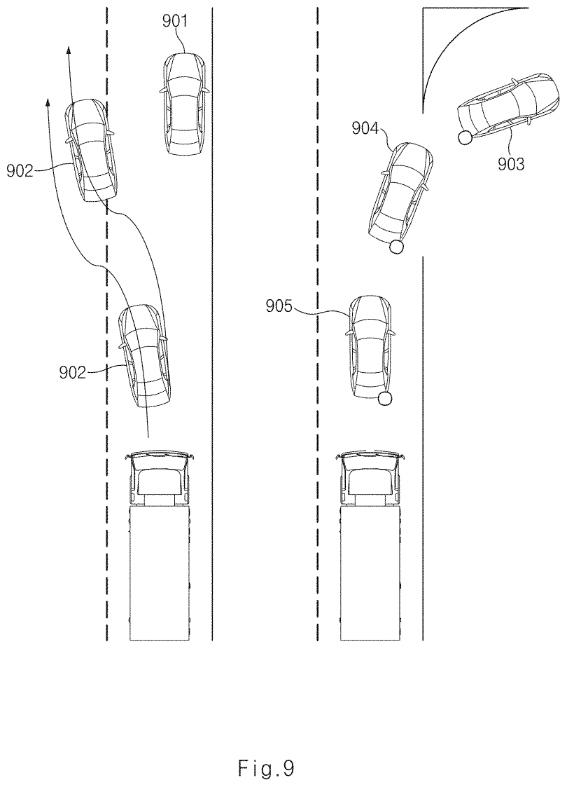

FIG. 9 is a drawing illustrating calculating a degree to which another vehicle interferes with traffic flow with regard to a driving path of a surrounding vehicle around the other vehicle in an apparatus for detecting a traffic flow obstruction target according to an embodiment of the present disclosure.

Referring to FIG. 9, a surrounding vehicle 902 around (i.e., proximate to) another vehicle 901 may bypass the other vehicle 901 to travel, i.e., to continue travelling.

In this regard, as the number of the surrounding vehicles 902 around the other vehicle 901, which bypass the other vehicle 901 to travel, increases, an apparatus 100 or 200 for detecting a traffic flow obstruction target in FIG. 1 or 2 may calculate a score corresponding to a degree to which the other vehicle 901 interferes with traffic flow to be high.

On the other hand, although other vehicles 903, 904, and 905 are stopped, they may be temporarily stopped due to vehicle congestion or intersection delays. In this case, a surrounding vehicle around the other vehicles 903, 904, and 905 may wait without bypassing the other vehicles 903, 904, and 905 to travel.

In this regard, when there is no surrounding vehicle around the other vehicle 903, 904, and 905, which bypasses the other vehicles 903, 904, and 905 to travel, the apparatus 100 or 200 for detecting the traffic flow obstruction target may fail to additionally assign a score corresponding to a degree to which the other vehicles 903, 904, and 905 interfere with traffic flow.

As an example, the apparatus 100 or 200 for detecting the traffic flow obstruction target may add a score in proportion to the number of surrounding vehicles around the other vehicle, which bypass the other vehicle to travel, to a score corresponding to a degree to which the other vehicle interferes with traffic flow.

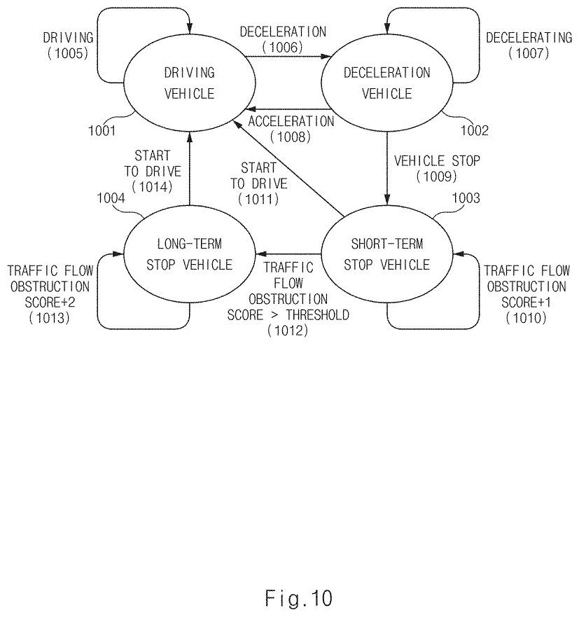

FIG. 10 is a drawing illustrating a finite state machine according to an embodiment of the present disclosure.

An apparatus 100 or 200 for detecting a traffic flow obstruction target in FIG. 1 or 2 may apply a driving history of another vehicle to a predetermined finite state machine to calculate a score corresponding to a degree to which the other vehicle interferes with traffic flow.

Referring to FIG. 10, the finite state machine may include a driving vehicle state 1001, a deceleration vehicle state 1002, a short-term stop vehicle state 1003, and a long-term stop vehicle state 1004.

As an example, when another vehicle continues driving (1005) in the driving vehicle state 1001, the finite state machine may be configured to maintain the driving vehicle state 1001.

As an example, when the other vehicle decelerates (1006) in the driving vehicle state 1001, the finite state machine may be configured to transition to the deceleration vehicle state 1002.

As an example, when the other vehicle continues decelerating (1007) in the deceleration vehicle state 1002, the finite state machine may be configured to maintain the deceleration vehicle state 1002.

As an example, when the other vehicle accelerates (1008) in the deceleration vehicle state 1002, the finite state machine may be configured to transition to the driving vehicle state 1001.

As an example, when the other vehicle is stopped (1009) in the deceleration vehicle state 1002, the finite state machine may be configured to transition to the short-term stop vehicle state 1003.

As an example, when the other vehicle continues a state (1010), which belongs to the short-term stop vehicle state 1003 during a specific time, the finite state machine may be configured to increase a score corresponding to a degree to which the other vehicle interferes with traffic flow by +1 point.

As an example, when the other vehicle starts to drive (1011) in the short-term stop vehicle state 1003, the finite state machine may be configured to transition to the driving vehicle state 1001.

As an example, when a score corresponding to a degree to which the other vehicle interferes with traffic flow is greater than a threshold (1012) in the short-term stop vehicle state 1003, the finite state machine may be configured to transition to the long-term stop vehicle state 1004.

As an example, when the other vehicle continues a state (1013), which belongs to the long-term stop vehicle state 1004 during a specific time, the finite state machine may be configured to increase a score corresponding to a degree to which the other vehicle interferes with traffic flow by +2 point.

As an example, when the other vehicle starts to drive (1014) in the long-term stop vehicle state 1004, the finite state machine may be configured to transition to the driving vehicle state 1001.

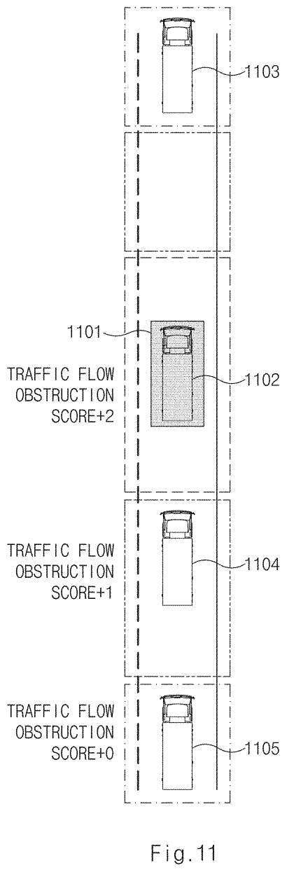

FIG. 11 is a drawing illustrating calculating a degree to which another vehicle interferes with traffic flow based on a position of the other vehicle with respect to a point, which interferes with traffic flow, in an apparatus for detecting a traffic flow obstruction target according to an embodiment of the present disclosure.

Referring to FIG. 11, a point 1101, which interferes with traffic flow, may be preset.

The point 1101, which interferes with the traffic flow, may include a road mark having a high parking and stop probability, for example, a bus stop or a taxi stand.

An apparatus 100 or 200 for detecting a traffic flow obstruction target in FIG. 1 or 2 may calculate a score corresponding to a degree to which another vehicle interferes with traffic flow, depending on a longitudinal position of the other vehicle with respect to the point 1101, which interferes with the traffic flow.

As an example, when another vehicle 1102 belongs to the point 1101, which interferes with the traffic flow, the apparatus 100 or 200 for detecting the traffic flow obstruction target may add +2 points to a score corresponding to a degree to which the other vehicle 1102 interferes with traffic flow.

As an example, when another vehicle 1103 is located in front of the point 1101, which interferes with the traffic flow in a driving direction, the apparatus 100 or 200 for detecting the traffic flow obstruction target may fail to add a score corresponding to a degree to which the other vehicle 1103 interferes with traffic flow.

As an example, when a longitudinal direction of another vehicle 1104 belongs in a specific distance to the point 1101, which interferes with the traffic flow, the apparatus 100 or 200 for detecting the traffic flow obstruction target may add +1 point to a score corresponding to a degree to which the other vehicle 1104 interferes with traffic flow.

As an example, when the longitudinal direction of another vehicle 1105 does not belong in the specific distance to the point 1101, which interferes with the traffic flow, the apparatus 100 or 200 for detecting the traffic flow obstruction target may add +0 point to a score corresponding to a degree to which the other vehicle 1105 interferes with traffic flow.

Although not illustrated, as an example, the apparatus 100 or 200 for detecting a traffic flow obstruction target may calculate a score corresponding to a degree to which another vehicle interferes with traffic flow, with regard to a lateral direction of the other vehicle with respect to the point, which interferes with the traffic flow.

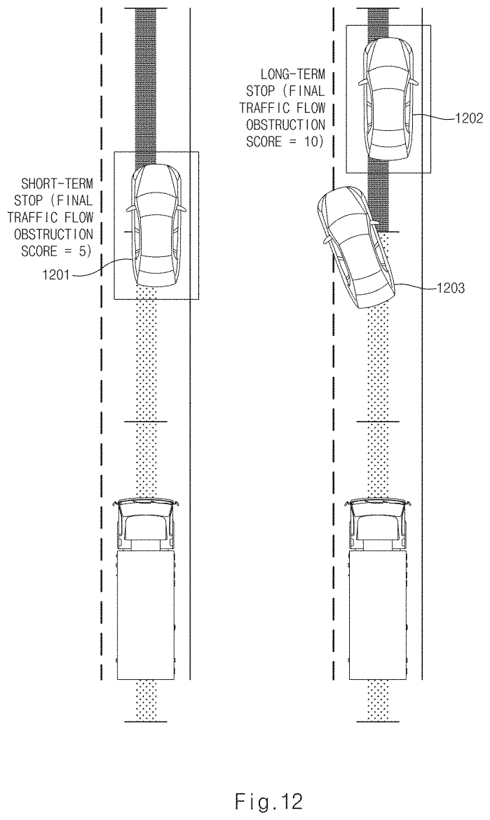

FIG. 12 is a drawing illustrating calculating a final degree to which another vehicle interferes with traffic flow in an apparatus for detecting a traffic flow obstruction target according to an embodiment of the present disclosure.

An apparatus 100 or 200 for detecting a traffic flow obstruction target in FIG. 1 or 2 may calculate a score determined by assigning a weight to scores corresponding to a degree to which another vehicle interferes with traffic flow, which are calculated according to respective criteria, as a final score corresponding to the degree to which the other vehicle interferes with the traffic flow.

Illustratively the apparatus 100 or 200 for detecting the traffic flow obstruction target may calculate a score, corresponding to a final degree to which another vehicle 1201 interferes with traffic flow for the other vehicle 1201 determined as a short-term stop vehicle state, as 5 points.

Furthermore, when it is determined that a surrounding vehicle 1203 bypasses another vehicle 1202 to travel, the apparatus 100 or 200 for detecting the traffic flow obstruction target may calculate a score, corresponding to a final degree to which the other vehicle 1202 interferes with traffic flow for the other vehicle 1202 determined as a long-term stop vehicle state, as 10 points.

When the score corresponding to the final degree to which the other vehicle interferes with the traffic flow is greater than a threshold, the apparatus 100 or 200 for detecting the traffic flow obstruction target may select the other vehicle as a traffic flow obstruction target.

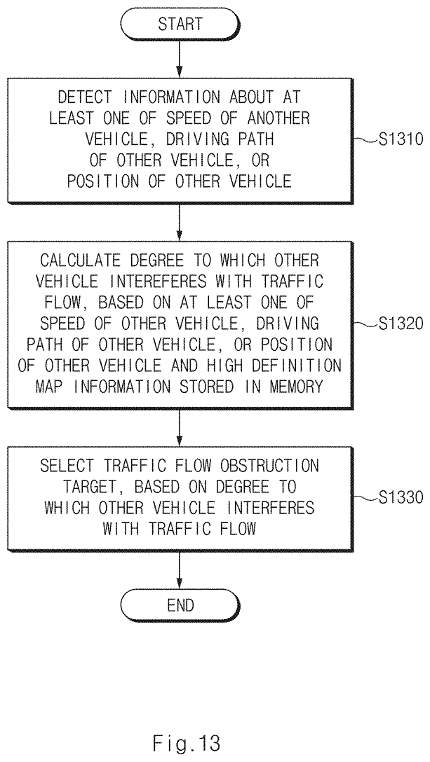

FIG. 13 is a flowchart illustrating a method for detecting a traffic flow obstruction target according to an embodiment of the present disclosure.

Referring to FIG. 13, the method for detecting the traffic flow obstruction target may include detecting (S1310) information about at least one of a speed of another vehicle, a driving path of the other vehicle, or a position of the other vehicle. The method may include calculating (S1320) a degree to which the other vehicle interferes with traffic flow based on the at least one of the speed of the other vehicle, the driving path of the other vehicle, or the position of the other vehicle and based on high definition map information stored in a memory. The method may also include selecting (S1330) a traffic flow obstruction target based on the degree to which the other vehicle interferes with the traffic flow.

The detecting (S1310) of the information about the at least one of the speed of the other vehicle, the driving path of the other vehicle, or the position of the other vehicle may be performed by a sensor device 120 or 220 of FIG. 1 or 2.

The detecting (S1310) of the information about the at least one of the speed of the other vehicle, the driving path of the other vehicle, or the position of the other vehicle may include detecting, by at least one of a LiDAR, a camera, or a radar, the information about the at least one of the speed of the other vehicle, the driving path of the other vehicle, or the position of the other vehicle.

The calculating (S1320) of the degree to which the other vehicle interferes with the traffic flow based on the at least one of the speed of the other vehicle, the driving path of the other vehicle, or the position of the other vehicle and based on the high definition map information stored in the memory may be performed by a processor 130 or 230 of FIG. 1 or 2.

As an example, the calculating (S1320) of the degree to which the other vehicle interferes with the traffic flow based on the at least one of the speed of the other vehicle, the driving path of the other vehicle, or the position of the other vehicle and based on the high definition map information stored in the memory may include calculating, by the processor 130 or 230, the degree to which the other vehicle interferes with the traffic flow with regard to at least one of an average speed according to a lane to which the other vehicle belongs, an average distance between vehicles according to the lane, or the number of vehicles occupying a reference distance section of the lane.

As an example, the calculating (S1320) of the degree to which the other vehicle interferes with the traffic flow based on the at least one of the speed of the other vehicle, the driving path of the other vehicle, or the position of the other vehicle and based the high definition map information stored in the memory may include calculating, by the processor 130 or 230, the degree to which the other vehicle interferes with the traffic flow with regard to information about a lane based on a lane link, a lane side, or a control path, which is identified by means of the high definition map information.

As an example, the calculating (S1320) of the degree to which the other vehicle interferes with the traffic flow based on the at least one of the speed of the other vehicle, the driving path of the other vehicle, or the position of the other vehicle and based on the high definition map information stored in the memory may include calculating, by the processor 130 or 230, the degree to which the other vehicle interferes with the traffic flow, with regard to a driving path of a surrounding vehicle around the other vehicle.

As an example, the calculating (S1320) of the degree to which the other vehicle interferes with the traffic flow based on the at least one of the speed of the other vehicle, the driving path of the other vehicle, or the position of the other vehicle and based on the high definition map information stored in the memory may include calculating, by the processor 130 or 230, the degree to which the other vehicle interferes with the traffic flow with regard to a driving intention of the other vehicle, which is determined based on a history of a driving state of the other vehicle.

As an example, the calculating of the degree to which the other vehicle interferes with the traffic flow with regard to the driving intention of the other vehicle by the processor 130 or 230 may include determining, by the processor 130 or 230, the driving intention of the other vehicle by applying the history of the driving state of the other vehicle to a predetermined finite state machine.

As an example, the calculating (S1320) of the degree to which the other vehicle interferes with the traffic flow based on the at least one of the speed of the other vehicle, the driving path of the other vehicle, or the position of the other vehicle and based on the high definition map information stored in the memory may include calculating, by the processor 130 or 230, the degree to which the other vehicle interferes with the traffic flow based on a position of the other vehicle with respect to a predetermined point which interferes with traffic flow.

As an example, the calculating (S1320) of the degree to which the other vehicle interferes with the traffic flow based on the at least one of the speed of the other vehicle, the driving path of the other vehicle, or the position of the other vehicle and based on the high definition map information stored in the memory may include calculating, by the processor 130 or 230, the degree to which the other vehicle interferes with the traffic flow with regard to at least one of whether a lamp of the other vehicle is turned on or whether there is a passenger in the other vehicle, which is determined by means of an image of the other vehicle.

As an example, the calculating (S1320) of the degree to which the other vehicle interferes with the traffic flow based on the at least one of the speed of the other vehicle, the driving path of the other vehicle, or the position of the other vehicle and based on the high definition map information stored in the memory may include calculating, by the processor 130 or 230, the degree to which the other vehicle interferes with the traffic flow with regard to at least one of a lighting state of the lamp, a starting state, or a state of a brake, which is included in information about the other vehicle.

As an example, the calculating (S1320) of the degree to which the other vehicle interferes with the traffic flow based on the at least one of the speed of the other vehicle, the driving path of the other vehicle, or the position of the other vehicle and based on the high definition map information stored in the memory may include calculating, by the processor 130 or 230, the degree to which the other vehicle interferes with the traffic flow based on varies other values. For example, such other values may include: a value added by assigning a weight to a value including at least one of a value calculated based on information about a lane; a value calculated based on a driving path of a surrounding vehicle around the other vehicle; a value calculated based on a history of a driving state of the other vehicle; a value calculated based on a position of the other vehicle with respect to a predetermined point which interferes with traffic flow; a value calculated based on an image obtained by means of a camera; or a value calculated based on information obtained through V2X communication.

The selecting (S1330) of the traffic flow obstruction target based on the degree to which the other vehicle interferes with the traffic flow may be performed by the processor 130 or 230.

As an example, the selecting (S1330) of the traffic flow obstruction target based on the degree to which the other vehicle interferes with the traffic flow may include determining, by the processor 130 or 230, whether a score corresponding to the degree to which the other vehicle interferes with the traffic flow is greater than a threshold to select the traffic flow obstruction target.

The operations of the method or the algorithm described in connection with the embodiments disclosed herein may be embodied directly in hardware or a software module executed by the processor or in a combination thereof. The software module may reside on a storage medium (i.e., the memory/or the storage) such as a RAM, a flash memory, a ROM, an EPROM, an EEPROM, a register, a hard disk, a removable disk, and a CD-ROM.

The storage medium may be coupled to the processor and the processor may read information out of the storage medium and may record information in the storage medium. Alternatively, the storage medium may be integrated with the processor. The processor and the storage medium may reside in an application specific integrated circuit (ASIC). The ASIC may reside within a user terminal. In another case, the processor and the storage medium may reside in the user terminal as separate components.

A description is given of effects of the apparatus for detecting the traffic flow obstruction target and the method thereof according to an embodiment of the present disclosure.

According to at least one of embodiments of the present disclosure, the apparatus for detecting the traffic flow obstruction target and the method thereof may be provided in an autonomous vehicle.

Furthermore, according to at least one of embodiments of the present disclosure, the apparatus for detecting the traffic flow obstruction target and the method thereof may be provided to detect a target causing bypass driving, which is present on a driving path, to enhance the completeness of autonomous driving.

Furthermore, according to at least one of embodiments of the present disclosure, the apparatus for detecting the traffic flow obstruction target and the method thereof may be provided to enhance the accuracy of detecting the traffic flow obstruction target with regard to other pieces of information in an overall manner other than a speed of a separate vehicle.

Furthermore, according to at least one of embodiments of the present disclosure, the apparatus for detecting the traffic flow obstruction target and the method thereof may be provided to set a bypass path based on the detected target to ensure stability of autonomous driving.

Furthermore, according to at least one of embodiments of the present disclosure, the apparatus for detecting the traffic flow obstruction target and the method thereof may be provided to provide autonomous driving capable of suitably coping with a vehicle parked and stopped on a shoulder, a vehicle which invades the line, a vehicle which attempts to narrow and enter an interval with a forward vehicle at an intersection, an accident section, a construction section, a bicycle or pedestrian situation on an end lane, or the like.

In addition, various effects ascertained directly or indirectly through the present disclosure may be provided.

Hereinabove, although the present disclosure has been described with reference to embodiments and the accompanying drawings, the present disclosure is not limited thereto. The embodiments may be variously modified and altered by those having ordinary skill in the art to which the present disclosure pertains without departing from the spirit and scope of the present disclosure claimed in the following claims.

Therefore, embodiments of the present disclosure are not intended to limit the technical spirit of the present disclosure but are provided only for the illustrative purpose.

The scope of the present disclosure should be construed on the basis of the accompanying claims. All the technical ideas within the scope equivalent to the claims should be included in the scope of the present disclosure.

What is claimed is:

1. An apparatus for detecting a traffic flow obstruction target, the apparatus comprising:
a memory storing high definition map information;
a sensor device provided in an autonomous vehicle to detect information about at least one of a speed of another vehicle, a driving path of the other vehicle, or a position of the other vehicle; and
a processor configured to calculate a degree to which the other vehicle interferes with traffic flow, based on the at least one of the speed of the other vehicle, the driving path of the other vehicle, or the position of the other vehicle and based on the high definition map information and configured to select the traffic flow obstruction target, based on the degree to which the other vehicle interferes with the traffic flow.

2. The apparatus of claim 1, wherein the processor calculates the degree to which the other vehicle interferes with the traffic flow, with regard to at least one of an average speed according to a lane to which the other vehicle belongs, an average distance between vehicles according to the lane, or the number of vehicles occupying a reference distance section of the lane.

3. The apparatus of claim 1, wherein the processor calculates the degree to which the other vehicle interferes with the traffic flow, with regard to information about a lane based on a lane link, a lane side, or a control path, the lane being identified by means of the high definition map information.

4. The apparatus of claim 1, wherein the processor calculates the degree to which the other vehicle interferes with the traffic flow with regard to a driving path of a surrounding vehicle around the other vehicle.

5. The apparatus of claim 1, wherein the processor calculates the degree to which the other vehicle interferes with the traffic flow with regard to a driving intention of the other vehicle, the driving intention being determined based on a history of a driving state of the other vehicle.

6. The apparatus of claim 5, wherein the processor determines the driving intention of the other vehicle by applying the history of the driving state of the other vehicle to a predetermined finite state machine.

7. The apparatus of claim 1, wherein the processor calculates the degree to which the other vehicle interferes with the traffic flow, based on a position of the other vehicle with respect to a predetermined point which interferes with traffic flow.

8. The apparatus of claim 1, further comprising:
a camera device configured to obtain an image of the other vehicle,
wherein the processor calculates the degree to which the other vehicle interferes with the traffic flow with regard to at least one of whether a lamp of the other vehicle is turned on or whether there is a passenger in the other vehicle, which is determined by means of the image of the other vehicle.

9. The apparatus of claim 1, further comprising:
a communication device configured to obtain information about the other vehicle through vehicle-to-everything (V2X) communication,
wherein the processor calculates the degree to which the other vehicle interferes with the traffic flow, with regard to at least one of a lighting state of a lamp, a starting state, or a state of a brake, which is included in the information about the other vehicle.

10. The apparatus of claim 1, wherein the processor calculates the degree to which the other vehicle interferes with the traffic flow, based on a value determined by assigning a weight to a value including at least one of a value calculated based on information about a lane, a value calculated based on a driving path of a surrounding vehicle around the other vehicle, a value calculated based on a history of a driving state of the other vehicle, a value calculated based on a position of the other vehicle with respect to a predetermined point which interferes with traffic flow, a value calculated based on an image obtained by means of a camera, or a value calculated based on information obtained through V2X communication.

11. A method for detecting a traffic flow obstruction target, the method comprising:
detecting, by a sensor device provided in an autonomous vehicle, information about at least one of a speed of another vehicle, a driving path of the other vehicle, or a position of the other vehicle;
calculating, by a processor, a degree to which the other vehicle interferes with traffic flow, based on the at least one of the speed of the other vehicle, the driving path of the other vehicle, or the position of the other vehicle and based on high definition map information stored in a memory; and
selecting, by the processor, the traffic flow obstruction target, based on the degree to which the other vehicle interferes with the traffic flow.

12. The method of claim 11, wherein the calculating of the degree to which the other vehicle interferes with the traffic flow by the processor includes:
calculating, by the processor, the degree to which the other vehicle interferes with the traffic flow with regard to at least one of an average speed according to a lane to which the other vehicle belongs, an average distance between vehicles according to the lane, or the number of vehicles occupying a reference distance section of the lane.

13. The method of claim 11, wherein the calculating of the degree to which the other vehicle interferes with the traffic flow by the processor includes:
calculating, by the processor, the degree to which the other vehicle interferes with the traffic flow with regard to information about a lane based on a lane link, a lane side, or a control path, the lane being identified by means of the high definition map information.

14. The method of claim 11, wherein the calculating of the degree to which the other vehicle interferes with the traffic flow by the processor includes:
calculating, by the processor, the degree to which the other vehicle interferes with the traffic flow with regard to a driving path of a surrounding vehicle around the other vehicle.

15. The method of claim 11, wherein the calculating of the degree to which the other vehicle interferes with the traffic flow by the processor includes:
calculating, by the processor, the degree to which the other vehicle interferes with the traffic flow with regard to a driving intention of the other vehicle, the driving intention being determined based on a history of a driving state of the other vehicle.

16. The method of claim 15, wherein the calculating of the degree to which the other vehicle interferes with the traffic flow with regard to the driving intention of the other vehicle, by the processor includes:
determining, by the processor, the driving intention of the other vehicle by applying the history of the driving state of the other vehicle to a predetermined finite state machine.

17. The method of claim 11, wherein the calculating of the degree to which the other vehicle interferes with the traffic flow by the processor includes:
calculating, by the processor, the degree to which the other vehicle interferes with the traffic flow, based on a position of the other vehicle with respect to a predetermined point which interferes with traffic flow.

18. The method of claim 11, further comprising:
obtaining, by a camera device, an image of the other vehicle,
wherein the calculating of the degree to which the other vehicle interferes with the traffic flow by the processor includes calculating, by the processor, the degree to which the other vehicle interferes with the traffic flow with regard to at least one of whether a lamp of the other vehicle is turned on or whether there is a passenger in the other vehicle, which is determined by means of the image of the other vehicle.

19. The method of claim 11, further comprising:
obtaining, by a communication device, information about the other vehicle through vehicle-to-everything (V2X) communication,
wherein the calculating of the degree to which the other vehicle interferes with the traffic flow by the processor includes calculating, by the processor, the degree to which the other vehicle interferes with the traffic flow with regard to at least one of a lighting state of a lamp, a starting state, or a state of a brake, which is included in the information about the other vehicle.

20. The method of claim 11, wherein the calculating of the degree to which the other vehicle interferes with the traffic flow by the processor includes:
calculating, by the processor, the degree to which the other vehicle interferes with the traffic flow, based on a value determined by assigning a weight to a value including at least one of a value calculated based on information about a lane, a value calculated based on a driving path of a surrounding vehicle around the other vehicle, a value calculated based on a history of a driving state of the other vehicle, a value calculated based on a position of the other vehicle with respect to a predetermined point which interferes with traffic flow, a value calculated based on an image obtained by means of a camera, or a value calculated based on information obtained through V2X communication.
